(19) United States
(12) Patent Application Publication
(10) Pub. No.: US 2015/0224479 A1
(43) Pub. Date: Aug. 13, 2015

(54) METHOD FOR PREPARING METAL CATALYST FOR PREPARING CARBON NANOTUBES AND METHOD FOR PREPARING CARBON NANOTUBES USING THE SAME

(71) Applicant: HANWHA CHEMICAL CORPORATION, Seoul (KR)

(72) Inventors: Shinje Cho, Gyeonggi-do (KR); Young Kwang Kim, Gyeonggi-do (KR); Su Young Park, Seoul (KR); Hana Kang, Jeollanam-do (KR); Young Chul Choi, Gyeonggi-do (KR)

(73) Assignee: HANWHA CHEMICAL CORPORATION, Seoul (KR)

(21) Appl. No.: 14/428,859

(22) PCT Filed: Sep. 17, 2013
(86) PCT No.: PCT/KR2013/008423

§ 371 Date: Mar. 17, 2015

(30) Foreign Application Priority Data
Sep. 18, 2012 (KR) 10-2012-0103442

(51) Int. Cl. B01J 23/75; B01J 37/04; C01B 31/02; B01J 21/02; B01J 35/02; B01J 35/00; B01J 37/00; B01J 37/08

(52) U.S. Cl. CPC B01J 23/75; B01J 37/0072; B01J 37/04; B01J 37/08; B01J 21/02; B01J 35/026; B01J 35/0006; B01J 35/0046; C01B 31/0233; C01P 2004/13

(57) ABSTRACT

A method of preparing a metal catalyst for preparing carbon nanotubes and a method of preparing carbon nanotubes using same. In one embodiment, a deposition-precipitation method is used. The method includes preparing a support dispersion solution in which a solid support is dispersed in a solvent; and injecting a metal precursor salt solution and a pH adjusting solution into the dispersion solution to prepare a mixed solution and adsorbing metal oxides or metal hydroxides formed therefrom on a surface of the solid support to prepare a catalyst particle.

### TECHNICAL FIELD

The present invention relates to a method for preparing a metal catalyst for preparing carbon nanotubes and a method for preparing carbon nanotubes using the same.

### BACKGROUND ART

A carbon nanotube has a shape in which a hexagonal honeycomb shaped graphite surface formed by bonds between one carbon atom and three other carbon atoms is roundly rolled to have a nano-sized diameter, and is a macromolecule having unique physical properties according to the size and shape thereof. The carbon nanotube is light due to being hollow therein and has electric conductivity as good as that of copper, thermal conductivity as excellent as that of diamond, and tensile strength corresponding to that of steel. As the carbon nanotube has a binding structure forming a cylindrical shape, even though impurities are not intentionally added, electronic properties of the carbon nanotube is changed from a conductor into a semiconductor due to interactions between the tubes. The carbon nanotube may be divided into a single walled nanotube (SWNT), a multi-walled nanotube (MWNT), and a rope nanotube according to the rolled shape.

As a method for synthesizing the carbon nanotube, generally, an arc-discharge method, a laser ablation method, a high pressure chemical vapor deposition method (CVD), an atmospheric pressure thermal chemical vapor deposition method, and the like, have been suggested. Among them, the arc-discharge method and the laser ablation method may be easily applied due to the simple principle thereof, but at the time of synthesizing carbon nanotube using these methods, large amounts of impurities may be included, and these methods are not suitable for mass production. On the other hand, as a method for synthesizing high purity carbon nanotube on a large scale at a low cost, the thermal chemical vapor deposition method has been known as the most suitable method.

A catalyst used to synthesize the carbon nanotube using the thermal chemical vapor deposition method also has a great influence on the synthesis. Generally, cobalt, iron, nickel, or the like, which is a transition metal, has been used, and carbon nanotube may be synthesized by a metal catalyst on a support.

An example of a method for preparing a metal catalyst may include a coprecipitation method of changing pH, a temperature, and/or a composition of a catalyst support and a catalyst metal or a metal combination in a solution state to coprecipitate and then separating precipitates to heat-treat the precipitates under air or another gas atmosphere, an (initial) impregnation method of heating, drying, and vaporizing a suspension containing a fine particle support material and a catalyst metal, a method of mixing a cationic fine particle support material such as zeolite with a catalyst metal salt to thereby be ionized and then reducing the ionized metal to a metal particle at a high temperature using hydrogen or another reduction means, a method of burning a catalyst metal and a solid oxide support material such as magnesia, alumina, silica, or the like, in a mixed state, or the like. In addition, a spray pyrolysis method of spraying/fining a catalyst metal precursor solution to burn the catalyst metal precursor solution has been disclosed in Korean Patent Laid-Open Publication No. 2003-0091016 (Patent Document 1), but most of the prepared catalysts have an average particle diameter of 0.1 to several micrometer, such that there was a limitation in fineness, or there was problems in that mass production of the catalyst was difficult or economical efficiency was deteriorated.

### RELATED ART DOCUMENT

### Patent Document

(Patent Document 1) Korea Patent Laid-Open Publication No. 2003-0091016

### DISCLOSURE

### Technical Problem

An object of the present invention is to provide a method for preparing a metal catalyst for preparing carbon nanotubes capable of synthesizing carbon nanotubes having a uniform aligned structure with a high yield, as compared to an amount of injected catalyst due to excellent loading uniformity by using a deposition-precipitation hybrid method.

### Technical Solution

In one general aspect, a method for preparing a metal catalyst for preparing carbon nanotubes, the method includes: preparing a support dispersion solution in which a solid support is dispersed in a solvent; and injecting a metal precursor salt solution and a pH adjusting solution into the dispersion solution to prepare a mixed solution and adsorbing metal oxides or metal hydroxides formed therefrom on a surface of the solid support to prepare a catalyst particle.

Hereinafter, the present invention will be described in detail.

The present invention relates to the method for preparing a metal catalyst for preparing carbon nanotubes using a deposition-precipitation hybrid method. In the deposition-precipitation hybrid method according to the present invention, the metal precursor salt solution and a pH adjusting agent reacts with each other in the support dispersion solution to form precipitates, and these precipitates are adsorbed and solidified on the surface of the support. The present invention was completed by finding that in this case, uniformity of the catalyst and a synthetic yield of the carbon nanotube are significantly improved as compared to metal catalysts prepared by the existing coprecipitation or impregnation method, such that the catalyst prepared by the deposition-precipitation hybrid method has an excellent catalytic activity as a metal catalyst for preparing the carbon nanotube.

In the method for preparing a metal catalyst for preparing carbon nanotubes, the metal precursor salt solution may be prepared by dissolving a transition metal precursor at a content of 30 to 100 parts by weight based on 100 parts by weight of a solvent. In the case in which the content is less than 30 parts by weight, an amount of solvent used in the total reaction is increased, such that it may be difficult to control the reaction, and in the case in which the content is more than 100 parts by weight, it may be difficult to dissolve the transition metal precursor.

The transition metal precursor according to the present invention is not particularly limited as long as a material contains a metal such as a metal salt, but preferably, a material containing one or at least two selected from a group consisting of metal salts containing iron, cobalt, nickel, yttrium, molybdenum, copper, platinum, palladium, vanadium, niobium, tungsten, chromium, iridium, and titanium may be used. In detail, it is more preferable that the transition metal precursor contains one or at least two selected from iron, cobalt, and molybdenum.

When the metal precursor solution is mixed with the pH adjusting solution, the metal precursor solution is solidified in a metal oxide or metal hydroxide particle form to thereby be adsorbed on the support, and may be precipitated in the mixed solution in a mixture catalyst particle form of the metal oxide (or metal hydroxide) and the support. In this case, the catalyst particle may have an average diameter of 0.1 to 100 μm.

In this case, the catalyst is prepared by adjusting a pH of the solution formed by adding the metal precursor salt solution and the pH adjusting solution to the support dispersion solution at 4 to 8. In the case in which the pH is less than 4, the metal oxide or metal hydroxide is not precipitated from the metal precursor, and in the case in which the pH is more than 8, a soluble metal complex is formed, such that it is impossible to obtain the desired precipitate form. At the time of preparing the metal catalyst for preparing carbon nanotubes according to the present invention, preferably, the pH may be adjusted between 6 to 8, which is effective in that this pH is suitable for forming the precipitate of the metal oxide or metal hydroxide from the transition metal precursor, such that precipitation of a fixed amount of the metal component may be induced.

In order to adjust the pH of the mixed solution, in the present invention, the pH adjusting solution may be used. The pH adjusting solution may contain the pH adjusting agent at a content of 5 to 50 parts by weight of based on 100 parts by weight of the solvent. In the case in which the content is less than 5 parts by weight, an amount of solvent used in the total reaction is increased, such that it may be difficult to control the reaction, and in the case in which the content is more than 50 parts by weight, it may be difficult to dissolve the pH adjusting agent.

The pH adjusting agent may be one or a mixture of at least two selected from a group consisting of sodium carbonate, sodium bicarbonate, potassium carbonate, potassium bicarbonate, ammonium carbonate, sodium hydroxide, and potassium hydroxide, but is not limited thereto as long as a material may adjust a pH.

Further, the support dispersion solution may be prepared by dispersing 10 to 80 parts by weight of the support based on 100 parts by weight of a solvent. In the case in which a content of the support is less than 10 parts by weight, free nucleation in the solvent may prominently occur rather than nucleation on the surface of the support on which the precipitate of the metal oxide or metal hydroxide is formed, which deteriorate loading efficiency to thereby deteriorate uniformity of the catalyst, and in the case in which the content is more than 80 parts by weight, the stirring of the catalyst mixed solution is not smoothly performed, such that the reaction may be non-uniform.

At the time of preparing the catalyst for preparing carbon nanotubes, the support may serve to adsorb fine particles of the metal oxide or metal hydroxide formed during a preparing process of the catalyst on the basis of a wide surface area to increase an active surface area of the catalyst. The support may be one or at least two selected from metal particles, inorganic particles, metal oxides, metal hydroxides, and carbon-based particles, but a kind of support is not particularly limited. In detail, one or at least two selected from an oxide group such as silica, aluminum oxide, zeolite, calcium oxide, strontium oxide, barium oxide, lanthanum oxide, indium oxide, or the like, an hydroxide group such as beryllium hydroxide, magnesium hydroxide, calcium hydroxide, strontium hydroxide, barium hydroxide, aluminum hydroxide, titanium hydroxide, chromium hydroxide, vanadium hydroxide, manganese hydroxide, zinc hydroxide, rubidium hydroxide, indium hydroxide, or the like, and a carbon-based support group such as carbon black, carbon fiber, graphite, graphene, carbon nanotube, carbon nanofiber, or the like, may be used.

The support may have an average particle diameter of 0.01 to 100 μm. In the case in which the average particle diameter is less than 0.01 μm, aggregation of the support particles is induced, such that it may be difficult to synthesize carbon nanotubes having the desired aligned structure form, and in the case in which the average particle diameter is more than 100 μm, a specific surface area of the particle is decreased, such that it may be difficult to uniformly load the metal oxide or metal hydroxide on the surface of the support particle. Preferably, the support may have an average particle diameter of 0.1 to 10 μm.

In the present invention, a solvent may be commonly used in the metal precursor salt solution, the pH adjusting solution, and the solid-support dispersion solution, and any solvent may be used as long as the solvent may dissolve the pH adjusting agent and disperse the support. As the solvent, one or a mixture of at least two selected from a group consisting of water, methanol, ethanol, propyl alcohol, isopropyl alcohol, ethylene glycol, and polyethylene glycol may be preferably used since these solvents may easily dissolve the transition metal precursor and the pH adjusting agent and maintain a suitable reaction temperature.

The mixed solution may be prepared by dropping and stirring 10 to 200 parts by weight of each of the metal precursor salt solution and the pH adjusting solution at the same time based on 100 parts by weight of the solid-support dispersion solution. In this case, a dropping rate of the metal precursor salt solution and the pH adjusting solution and a ratio therebetween are adjusted so that the pH of the mixed solution may be suitably maintained.

In preparing the catalyst mixed solution, a heating temperature may be 25 to 150° C. In the case in which the heating temperature is less than 25° C., nucleation at the time of forming the metal oxide or metal hydroxide may be deteriorated, such that uniformity of the catalyst may be deteriorated, and in the case in which the heating temperature is more than 150° C., since a problem such as vaporization of the solvent may occur, at the time of selecting the solvent, a boiling point, or the like, should be considered, such that selection of the solvent may be limited. More preferably, in view of improving the uniformity of the catalyst to increase a catalytic activity, it is effective that the heating temperature is adjusted between 60 to 100° C.

After the catalyst mixed solution is prepared, metal catalyst for preparing carbon nanotubes may be prepared in a powder form by performing a filtering and washing process of the precipitates in the catalyst mixed solution and a drying and grinding process.

The drying may be performed at 60 to 250° C. for 6 to 36 hours. When the drying temperature is less than 60° C., a drying time may be increased, and when the drying temperature is more than 250° C., the catalyst may be excessively oxidized or aggregated. The drying may be performed under one gas or a mixture of at least two gases selected from air, oxygen, argon, nitrogen, helium, and hydrogen, but is not particularly limited thereto.

The prepared metal catalyst powder for preparing carbon nanotubes may have an average particle diameter of 0.1 to 100 μm, preferably 0.5 to 10 μm. In this case, since the surface of the catalyst may be sufficiently exposed, at the time of synthesizing the carbon nanotube, a reaction gas may uniformly contact the catalyst, such that high synthetic yield and uniformity may be secured.

A catalyst according to the present invention obtained by the above-mentioned method is also included in the scope of the present invention.

In addition, carbon nanotubes may be prepared by a general method in the art such as a thermal chemical vapor deposition method, or the like, using the catalyst according to the present invention. This method for preparing carbon nanotubes using the catalyst according to the present invention and the carbon nanotubes are also included in the scope of the present invention.

### Advantageous Effects

According to the present invention, a catalyst is prepared by adsorbing a metal catalyst component for preparing carbon nanotubes on a support in a solid form of metal oxides or metal hydroxides rather than a liquid form. In the metal catalyst for preparing carbon nanotubes having this form, a use rate of a metal component, which is an active component of the catalyst, may be high, such that a synthetic yield of the carbon nanotube may be high, side reactions may be small, and carbon nanotubes having a more uniform shape may be synthesized. Therefore, at the time of preparing carbon nanotubes, carbon nanotubes having high purity, high yield, and excellent uniformity may be prepared, such that the metal catalyst according to the present invention may be widely used as a catalyst for preparing carbon nanotubes capable of increasing productivity at the time of mass-production.

### DESCRIPTION OF DRAWINGS

FIG. 1 is a scanning electronic microscope (SEM) photograph of a metal catalyst for preparing carbon nanotubes prepared in Example 1.

FIG. 2 is a transmission electronic microscope (TEM) photograph of the metal catalyst for preparing carbon nanotubes prepared in Example 1.

FIG. 3 is a scanning electronic microscope (SEM) photograph of a metal catalyst for preparing carbon nanotubes prepared in Comparative Example 1.

FIG. 4 is a scanning electronic microscope (SEM) photograph of a metal catalyst for preparing carbon nanotubes prepared in Comparative Example 2.

FIG. 5 is a scanning electronic microscope (SEM) photograph of carbon nanotubes prepared in Preparation Example using the metal catalyst for preparing carbon nanotubes prepared in Example 1.

FIG. 6 is a scanning electronic microscope (SEM) photograph of carbon nanotubes prepared in the Preparation Example using the metal catalyst for preparing carbon nanotubes prepared in Comparative Example 1.

FIG. 7 is a scanning electronic microscope (SEM) photograph of carbon nanotubes prepared in the Preparation Example using the metal catalyst for preparing carbon nanotubes prepared in Comparative Example 2.

FIG. 8 is a view showing electric properties of the carbon nanotube synthesized in Preparation Example 1 in a low density polyethylene (LDPE) polymer composite.

FIG. 9 is a process chart of Example 1.

### DETAILED DESCRIPTION OF MAIN ELEMENTS

1: Metal precursor salt solution
2: pH adjusting solution
3: Support dispersion solution
3′: catalyst mixed solution
4: pH meter
5: mechanical stirrer

### BEST MODE

### Example 1

### Preparation of Metal Catalyst for Preparing Carbon Nanotubes

1. 34.16 g of iron (III) nitrate nonahydrate and 13.27 g of cobalt (II) nitrate hexahydrate were put into 100 mL of distilled water as transition metal precursors and stirred for 10 minutes using a magnetic stirrer so as to be completely dissolved, thereby preparing a transition metal precursor solution.

2. 100 g of ammonium carbonate ((NH₄)₂CO₃) was put into 400 mL of distilled water as a pH adjusting agent and mixed with each other for 2 hours using a bath type ultrasonicator so as to be completely dissolved, thereby preparing a pH adjusting solution.

3. 100 g of aluminum hydroxide (Al(OH)₃) was put into 200 mL of distilled water in a 2 L beaker as a support and mixed, thereby preparing a support dispersion solution.

4. The transition metal precursor solution and the pH adjusting solution were dropped at a rate of 15 ml/min using a dropping funnel while stirring the prepared support dispersion solution using a mechanical stirrer and at the same time, a pH state of the solution was adjusted in real-time at 7.5 using a pH meter, thereby preparing a catalyst mixed solution.

5. The filtrates were filtered by filtering the prepared catalyst mixed solution under vacuum in Buchner funnel, washed by pouring 1 L of distilled water 3 times, and then dried in a box-type oven at 150° C. for 16 hours. The dried catalyst was ground in a 300 cc mixer for 10 seconds 5 times, thereby preparing a catalyst in a powder form.

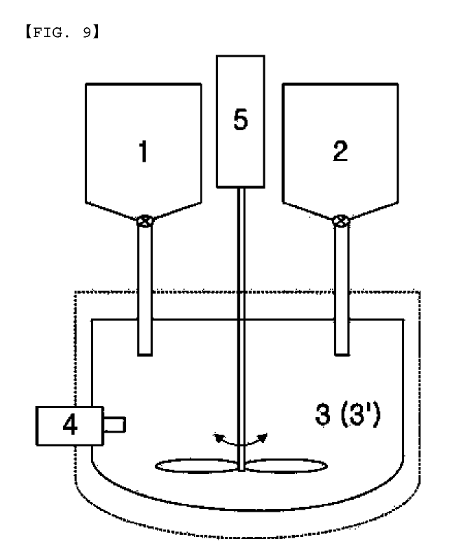

A process chart of Example 1 was shown in FIG. 9.

### Comparative Example 1

### Preparation of Metal Catalyst for Preparing Carbon Nanotubes by Impregnation Method

1. 34.16 g of iron (III) nitrate nonahydrate and 13.27 g of cobalt (II) nitrate hexahydrate were put into 100 mL of distilled water as transition metal precursors and mixed with each other for 10 minutes using a magnetic stirrer so as to be completely dissolved, thereby preparing a transition metal precursor solution.

2. 100 g of aluminum hydroxide (Al(OH)₃) was added thereto as a support and mixed with each other using a mechanical stirrer, thereby preparing catalyst slurry.

3. After the prepared catalyst slurry was dried in a box-type oven at 150° C. for 16 hours, the dried catalyst was ground in a 300 cc mixer for 10 seconds 5 times, thereby preparing a catalyst in a powder form.

### Comparative Example 2

### Preparation of Metal Catalyst for Preparing Carbon Nanotubes by Coprecipitation Method

1. 34.16 g of iron (III) nitrate nonahydrate, 13.27 g of cobalt (II) nitrate hexahydrate, and 500 g of aluminum nitrate nonahydrate were put into 100 mL of distilled water and mixed with each other for 10 minutes using a magnetic stirrer so as to be completely dissolved, thereby preparing an aqueous catalyst precursor solution.

2. 100 g of ammonium carbonate as a pH adjusting agent was put into 400 mL of distilled water and then mixed with each other using a bath type ultrasonicator for 2 hours so as to be completely dissolved, thereby preparing a pH adjusting solution.

3. The pH adjusting solution was dropped at a rate of 15 ml/min using a dropping funnel while stirring the prepared aqueous catalyst precursor solution using a mechanical stirrer and at the same time, a pH state of the solution was adjusted in real-time at 7.5 using a pH meter, thereby preparing a catalyst mixed solution.

4. The filtrates were filtered by filtering the prepared catalyst mixed solution under vacuum in Buchner funnel, washed by pouring 1 L of distilled water 3 times, and then dried in a box-type oven at 150° C. for 16 hours. The dried catalyst was ground in a 300 cc mixer for 10 seconds 5 times, thereby preparing a catalyst in a powder form.

### Preparation Example 1

### Preparation of Carbon Nanotubes

1. Carbon nanotubes were prepared using the catalysts obtained in the Example and Comparative Examples by a thermal chemical vapor deposition method, and the preparation method was as follows. 0.5 g of the catalyst was uniformly applied onto a quartz boat and then positioned in the center of a quartz tube having a diameter of 190 nm. After a temperature of a reactor was raised to 700° C. under nitrogen atmosphere, ethylene gas (1SLM) and hydrogen gas (1SLM) were injected at a ratio of 1:1 for 30 minutes, thereby preparing carbon nanotubes.

### Experimental Example 1

### Catalyst Shape Analysis

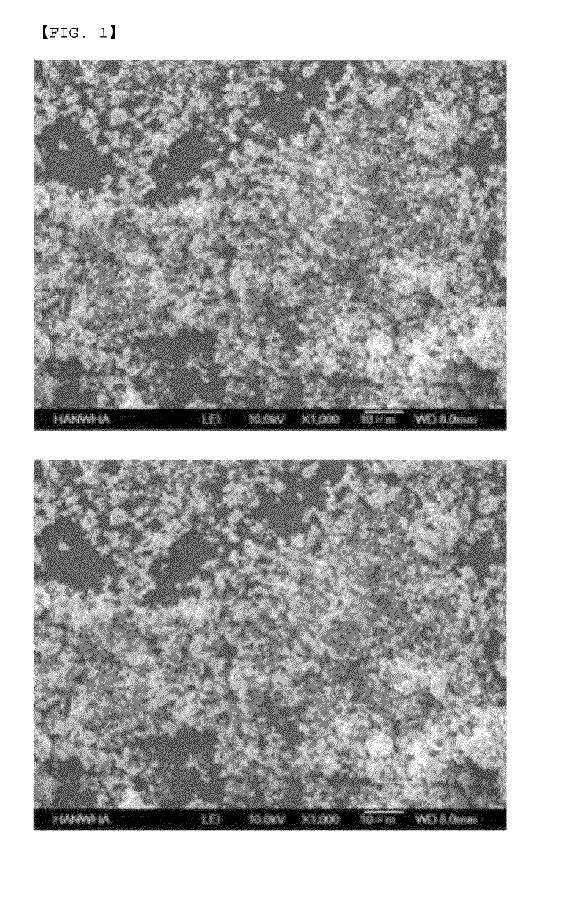

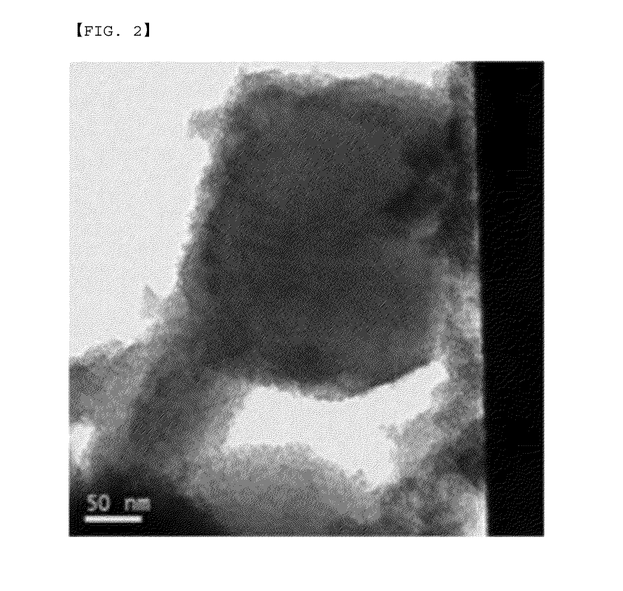

In order to analyze a shape of the metal catalyst for preparing carbon nanotubes prepared in Example 1, the shape was observed using a scanning electronic microscope (SEM) and a transmission electronic microscope (TEM), and a SEM photograph and a TEM photograph were shown in FIGS. 1 and 2, respectively.

It was observed that an average diameter of the metal catalyst for preparing carbon nanotubes prepared in Example 1 was 1.4 μm.

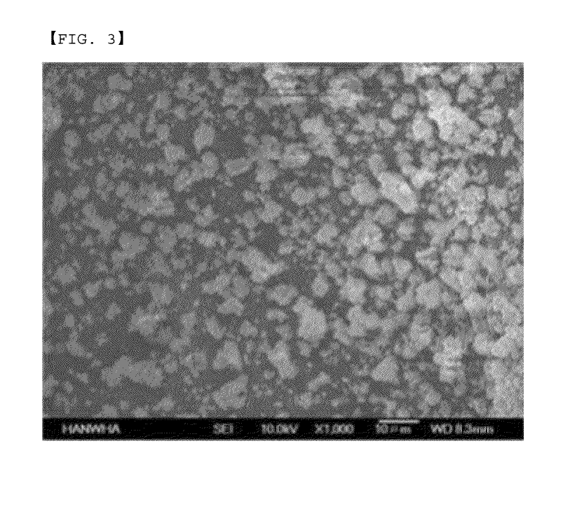

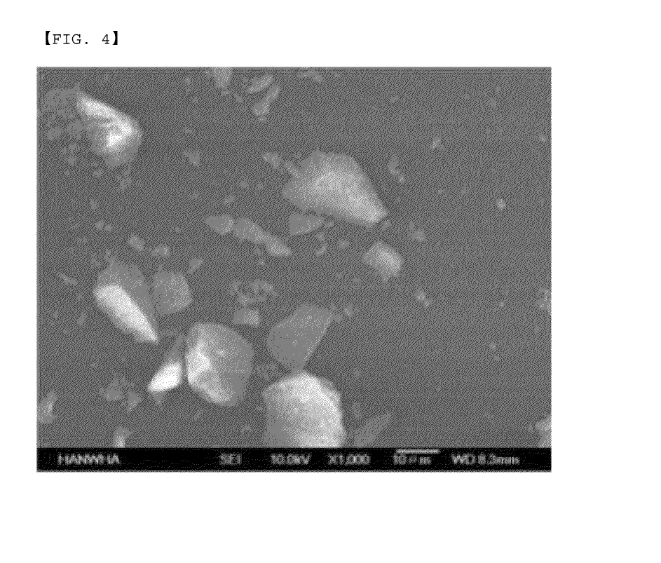

In addition, shapes of the metal catalysts for preparing carbon nanotubes prepared in Comparative Examples and 2 were observed using a scanning electronic microscope (SEM), and SEM photographs of the metal catalysts prepared in Comparative Examples 1 and 2 were shown in FIGS. 3 and 4, respectively. As a result of analysis, it was confirmed that average diameters of the metal catalysts prepared in Comparative Examples 1 and 2 were 23 μm and 140 μm, respectively.

### Experimental Example 2

### Carbon Yield Measurement

In order to evaluate catalytic activities of the metal catalysts for preparing carbon nanotubes prepared in the Example and Comparative Examples, a carbon yield of the carbon nanotubes synthesized in Preparation Example 1 using the corresponding catalyst was defined as follows and measured.

Carbon Yield (%)={(weight of collected carbon nanotubes)−(weight of injected catalyst)}/(weight of injected catalyst)×100

The corresponding results were shown in Table 1.

TABLE 1

| | | Comparative | Comparative |
|---|---|---|---|
| | Example 1 | Example 1 | Example 2 |
| Catalyst particle | Average 1.4 | Average 23 | Average 140 |
| size (μm) | | | |
| Carbon yield (%) | 1050 | 320 | 450 |
| Carbon nanotube | Aligned structure | Partially aligned | Entangled |
| structure | | structure | structure |
| Carbon purity (%) | 90 | 80 | 80 |

### Experimental Example 3

### Carbon Purity Measurement

In order to evaluate catalytic activities of the metal catalysts for preparing carbon nanotubes prepared in the Example and Comparative Examples, a carbon purity of the carbon nanotubes synthesized in Preparation Example 1 using the corresponding catalyst was defined as follows and measured. The carbon purity was calculated according to the following Equation by analyzing a residual amount after performing a thermo-gravimetric analysis up to 800° C. at a heating rate of 10° C./min under air atmosphere using a thermo-gravimetric analyzer (TGA).

Carbon purity (%)=(weight ratio (%) at room temperature)−(residual weight ratio (%) at 800° C.)

The corresponding results were shown in Table 1.

### Experimental Example 4

### Carbon Nanotube Shape Analysis

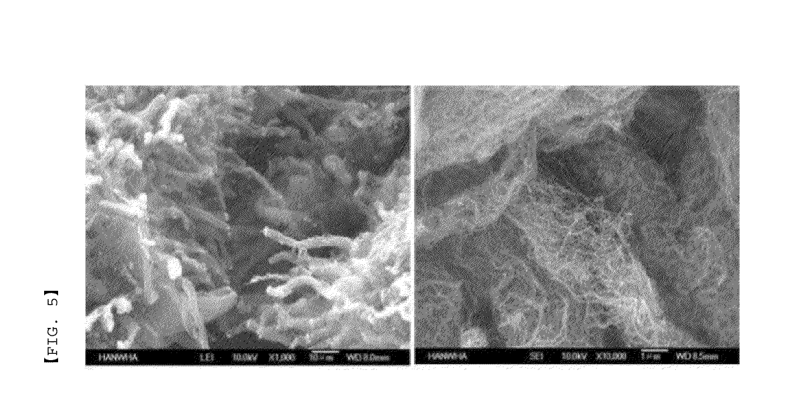

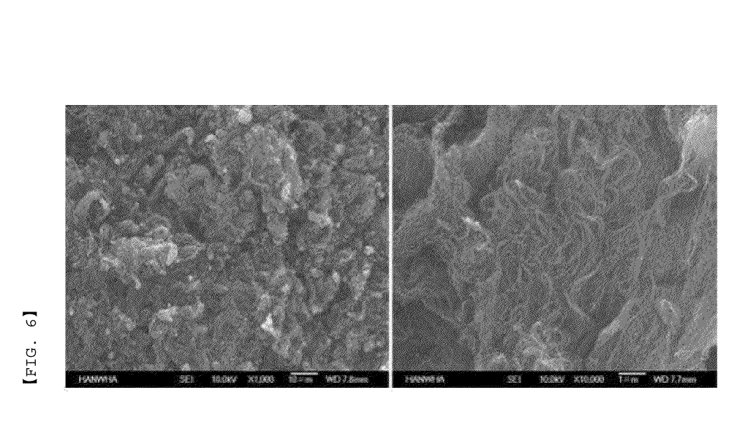

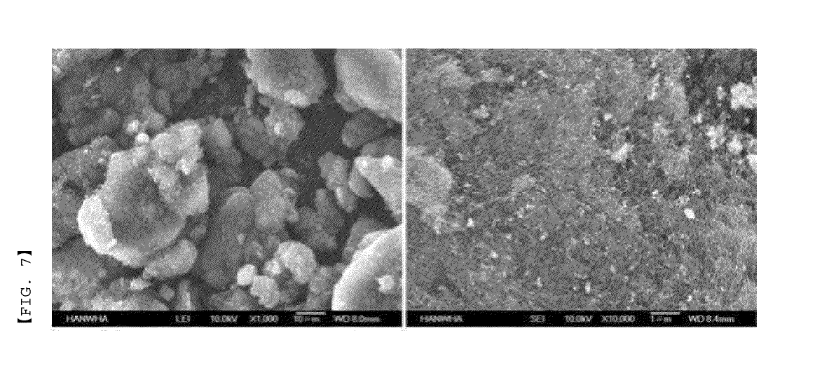

In order to evaluate catalytic activities of the metal catalysts for preparing carbon nanotubes prepared in Example 1 and Comparative Examples 1 and 2, the shape of the carbon nanotube in Preparation Example 1 using the corresponding catalyst was observed using a scanning electronic microscope (SEM) and a transmission electronic microscope (TEM). The measurement results were shown in Table 1, and the shapes obtained using the SEM were shown in FIG. 5, (Example 1), FIG. 6 (Comparative Example 1), and FIG. 7 (Comparative Example 2), respectively.

### Experimental Example 5

### Carbon Nanotube Properties Evaluation

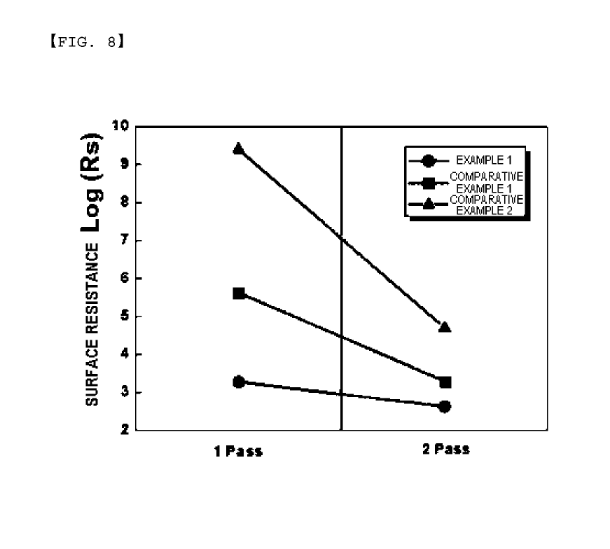

In order to evaluate catalytic activities of the metal catalysts for preparing carbon nanotubes prepared in the Example and Comparative Examples, dispersion behavior and electric properties of the carbon nanotube in Preparation Example 1 using the corresponding catalyst in a polymer composite were confirmed. To this end, a carbon nanotube/polyethylene (CNT/PE) composite pellet to which the carbon nanotube (20) was added was manufactured by performing extrusion at 180° C. using a twin screw extruder. After the manufactured composite pellet was passed through the same extruder to manufacture a pellet (2-pass pellet), a sample having a width of 20 cm, a length of 20 cm, and a thickness of 3 mm was manufactured by applying heat (180° C.) and pressure (30 ton) to each of the pellets. Then, surface resistance of the sample was measured, and the result was shown in FIG. 8.

1. A method for preparing a metal catalyst for preparing carbon nanotubes, the method comprising:
preparing a support dispersion solution in which a solid support is dispersed in a solvent; and
injecting a metal precursor salt solution and a pH adjusting solution into the dispersion solution to prepare a mixed solution and adsorbing metal oxide or metal hydroxide formed therefrom on a surface of the solid support to prepare a catalyst particle.

2. The method of claim 1, wherein in the metal precursor salt solution, 30 to 100 parts by weight of a transition metal precursor is dissolved therein based on 100 parts by weight of a solvent.

3. The method of claim 2, wherein the transition metal precursor is one or at least two selected from a group consisting of metal salts including iron, cobalt, nickel, yttrium, molybdenum, copper, platinum, palladium, vanadium, niobium, tungsten, chromium, iridium, and titanium.

4. The method of claim 1, wherein the pH adjusting solution contains 5 to 50 parts by weight of a pH adjusting agent based on 100 parts by weight of a solvent.

5. The method of claim 4, wherein the pH adjusting agent is one or a mixture of at least two selected from a group consisting of sodium carbonate, sodium bicarbonate, potassium carbonate, potassium bicarbonate, ammonium carbonate, sodium hydroxide, and potassium hydroxide.

6. The method of claim 1, wherein the solid support dispersion solution contains 10 to 80 parts by weight of the support based on 100 parts by weight of a solvent.

7. The method of claim 1, wherein the solid support is one or at least two selected from metal particles, inorganic particles, metal oxides, metal hydroxides, and carbon-based particles.

8. The method of claim 1, wherein each of the solvents is one or a mixture of at least two selected from water, methanol, ethanol, propyl alcohol, isopropyl alcohol, ethylene glycol, and polyethylene glycol.

9. The method of claim 1, wherein the mixed solution is prepared by dropping and stirring 10 to 200 parts by weight of each of the metal precursor salt solution and the pH adjusting solution at the same time, based on 100 parts by weight of the support dispersion solution.

10. The method of claim 1, wherein the metal oxide has an average diameter of 0.1 to 100 μm.

11. The method of claim 7, wherein the solid support has an average diameter of 0.01 to 100 μm.

12. The method of claim 1, wherein a temperature of the mixed solution is maintained at 25 to 150° C.

13. The method of claim 1, further comprising drying the metal oxide or metal hydroxide adsorbed on the surface of the solid support at 60 to 250° C. for 6 to 36 hours under one gas or a mixture of at least two gas selected from air, oxygen, argon, nitrogen, helium, and hydrogen.

14. A metal catalyst for preparing carbon nanotubes prepared by the method of claim 1.

15. A method for preparing carbon nanotubes using the metal catalyst for preparing carbon nanotubes of claim 14.
